(19) United States
(12) Patent Application Publication
(10) Pub. No.: US 2016/0125891 A1
(43) Pub. Date: May 5, 2016

(54) ENVIRONMENT-BASED COMPLEXITY REDUCTION FOR AUDIO PROCESSING

(71) Applicant: INTEL CORPORATION, Santa Clara, CA (US)

(72) Inventors: PHANI KUMAR NYSHADHAM, Bangalore (IN); Sreekanth Nakkala, Chittoor (IN)

(21) Appl. No.: 14/529,600

(22) Filed: Oct. 31, 2014

(51) Int. Cl. G10L 21/02

(52) U.S. Cl. CPC G10L 21/02

(57) ABSTRACT

Audio processing complexity is reduced based on an environment. In one example, a current environment of a mobile device is determined. A profile is selected based on the current environment. An audio processing pipeline is configured based on the selected profile and audio received at the mobile device is processed through the configured audio processing pipeline.

### FIELD

The present description relates to reducing complexity for audio processing based on the environment.

### BACKGROUND

Portable telephones incorporate a variety of different audio, feedback, and speech processing techniques to improve the quality of the sound played into the speaker and the quality of the sound received from a microphone. The apparent sound quality in a telephone call or in recorded video directly affects the usability of the telephone and a user's impression of the quality of the telephone. The quality of speech is a factor for maintaining intelligible conversation between the source and the destination. As portable telephones and especially cellular telephones become more powerful, sophisticated speech enhancement techniques are used resulting in complex processing. Many cellular telephones also include dedicated hardware including microphones, analog circuits, and digital speech processing circuits to improve incoming and outgoing voice quality. Some cellular telephones are equipped with advanced DSP's (Digital Signal Processors) capable of implementing sophisticated speech and audio enhancement modules to improve the speech quality in adverse conditions.

Many of the voice quality improvements consume battery power or central processing unit computing resources. Many of the speech enhancement modules actively run in the background during every conversation. The user has little or no control over these modules. In many cases the modules run during every conversation irrespective of need. This increases power consumption at the portable telephone.

In some portable telephones, several profiles are maintained in memory. Each profile launches a specific predetermined set of modules when a speech call is activated. The particular modules are determined by the particular profile that is activated. The profiles typically correspond to only a few different configurations that can easily and quickly be determined by the portable telephone. These profiles are related to the mode of use of the portable telephone which in turn activates and configures a set of modules tuned for the related mode of use. For example, there may be a speech processing profile for using the handset handheld to the ear, using the handset in speaker mode, using the handset with a wired headset attached, and using the handset through a Bluetooth hands free mode.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a diagram of a user interface that may be used to select an audio environment according to an embodiment.

FIG. 2 is a process flow diagram of setting an audio processing configuration according to an embodiment.

FIG. 3 is a process flow diagram of detecting artifacts in a module to determine an audio processing configuration for the module according to an embodiment.

FIG. 4 is a process flow diagram for selecting an environment using sensors and setting an audio processing configuration according to an embodiment.

FIG. 5 is a process flow diagram of setting an audio processing configuration based on environment selection data according to an embodiment.

FIG. 6 is a block diagram of an audio pipeline according to an embodiment.

FIG. 7 is a block diagram of a computing device incorporating audio processing according to an embodiment.

### DETAILED DESCRIPTION

Audio processing modules for an audio recording device, audio transmitting, or audio receiving device may be selected based on need and usefulness. In a portable device such as a portable or cellular telephone or a video camera, audio processing modules consume battery power. Therefore, the battery will last longer by limiting the audio processing. The more precisely the audio processing is controlled, the better the battery life may be. The battery drain caused by audio processing increases with higher resolution audio signals. Audio may be in a generalized form in which, for example, a concert, performance, or noise is being recorded, or it may specifically be speech. Audio may be sampled at different rates. Speech may also be sampled at different rates. The higher the sampling rates, the more power the processor draws for audio processing. With the advent of high-fidelity speech communication standards like Super-Wideband which supports sampling rates such as 24/32 KHz and Full-Band supporting sampling rates of 48 KHz, power consumption increases.

Speech processing modules that are typically used in portable telephones may be characterized in terms of required operations. One measure of processing requirements is MCPS (million cycles per second) which is related directly to the power consumption of the module. While the MCPS measurement and related power drain depends on the specific operation of the module and how it is implemented, relative numbers can be established.

Acoustic echo cancellers are widely used to reduce linear echo. The best case MCPS configuration would be one that is tuned for an open air environment. The worst case MCPS configuration would be one that is tuned for closed ambience. The processing load is more than twice as high when the sample rate is doubled. In addition, by tuning the operation of the AEC module, the processing load may be greatly increased or reduced.

The complexity of a noise reduction technique can also affect the processing load. When advanced noise reduction techniques are used, MCPS consumption may be many times the consumption of normal noise reduction. As an example, dual microphone noise reduction can greatly increase the processing load. With more than two microphones there is a further increase in MCPS. Significant power savings may be realized by turning off the noise reduction or limiting it to just one or two microphones depending on the environment. In a quiet room environment, such as a closed room or a living room, advanced noise reduction techniques may not be needed.

In the same way advanced noise reduction techniques, such as traffic noise reduction (TNR) and wind noise reduction (WNR), may be turned off completely for closed rooms or quiet environments. In open air environments or auditoriums echo cancellation may be turned off or echo cancellation may be reconfigured to a minimum configuration with reduced MCPS and to meet reduced performance demands of a particular environment.

Rather than relying only on the mode of usage of the device for selecting different audio processing configurations, environment-based configurations may also or alternatively be used. An appropriate profile or configuration may be identified based on the surrounding environment of the user that activates only the required speech enhancement modules but not all.

As a result, the speech enhancement modules which are not needed for the current environment are turned off to reduce power consumption. For example, if the user is in a quiet or acoustically clean environment, advanced noise reduction modules involving multi-microphones may be disabled. Even for the required modules, the configuration of a module may be modified based on the user's environment. With sufficient reductions in processing demands, the clock settings for the processor may even be reduced, reducing power consumption further. Low power scenarios may also be coupled with environment selections. Some modules may be minimized or turned off providing even more power efficient profiles. These may be used when battery power is low to maintain reasonable performance while still increasing battery longevity.

During, for example, a speech call over a mobile device, such as a smartphone, speech enhancement modules inside the device enhance the user experience by suppressing different types of background noise and by cancelling echoes. This improves the signal-to-noise and signal-to-echo ratios so that the parties on both ends of the call experience better intelligibility. Typically, the enhancement modules that perform this speech enhancement run on dedicated processors in what may be called a homogeneous design. In a heterogeneous design, the processing of the enhancement modules may be split across several different processors. In both cases, the additional processing increases the power demands.

In many mobile device architectures, the audio enhancement and processing modules can be activated and configured through commands. The parameters specific to the modules are part of a module command that is stored in NVM (Non Volatile Memory). Many mobile devices include several use-case profiles residing inside NVM based on the mode of usage of the device. Each profile maps to a specific set of modules and hence to a specific command configuration for each of those modules. Each configuration corresponds to a very particular mode of usage such as Handset mode, Headset mode, Bluetooth mode, Hands-free mode, etc.

In the mode based profiles, irrespective of the need for a particular enhancement, most of the enhancement modules will be activated all the time for that mode. As an example, if the user is in a clean environment without any background noise, the advanced noise-reduction algorithms should not be needed. However, the nature of the environment is not related to the usage mode. While such profiles provide some guidance in the selection of speech processing modules, such profiles are not very precise. For example, if the selected usage mode profile is “Handset mode”, all the noise reduction modules will be activated, even if the mobile device is in a clean environment. Any power used for the noise reduction modules is wasted power and impacts the battery life.

By considering the surrounding environment alone or in addition to the usage mode, the operation of the audio enhancement modules is better controlled. Power-efficient methods may be used to activate only the needed enhancement modules based on the surrounding environment of the user. In addition the configuration of an audio enhancement module may be modified for different environments. Different configurations of a module may result in different amounts of power consumption. This environment-based module activation is not only applicable for speech calls but also for audio recording cases.

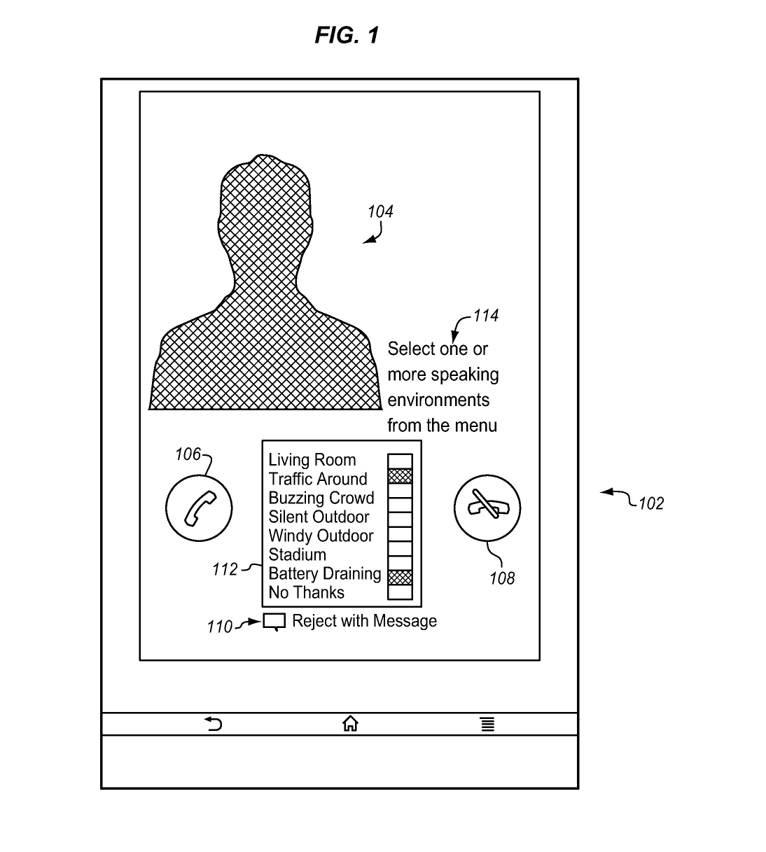

The environment may be selected or determined in a variety of different ways. In one embodiment, the user manually selects the environment. This may be done by voice command, by selection on a touch screen, by a key press, or using any of a variety of other user interfaces presented with a menu from which the environment can be selected. FIG. 1 is a diagram of a user interface (UI) that may be used for selecting an environment.

In FIG. 1, a UI 102 presents an alert 104 to the user that there is an incoming call. The alert may present an image associated with the caller or any other visual and audio cue. Such an alert is typically associated with ringing, vibrating and other alerts so that the user is aware that there is an incoming call. The UI presents normal options that may be activated using a touch screen, buttons or in any other way. These include a button to answer the call 106, to reject the call 108, or to reject the call and send a text message 110 or other type of message to the caller.

In addition, the UI presents an option to select an environment. In this case, the environment is presented as a list 112. The user manually selects an environment by touching one of the options on the list. The list may be accompanied by an audio or visual reminder 114 such as “select one or more speaking environments from the menu.” In the illustrated example, the environments are: living room; traffic around; buzzing crowd; silent outdoor; windy outdoor; stadium; battery draining; and no thanks when the user declines to select an environment. In this example, traffic around and battery draining are already selected. The user can accept these selections by doing nothing or may change to a different selection. These selections may be made by the mobile device using a previous selection or using sensors on the mobile device in a variety of different ways described in more detail below.

The mobile device includes these additional environment-based power-efficient profiles so that it may enable and configure the audio processing modules specifically for specific environments. These profiles are exposed to the user so that the user can choose the relevant profile based on the current surrounding environment. For example, when the user is in an open air environment, one of the outdoors profiles is chosen. This profile will have the Acoustic Echo Canceller (AEC) configured with fewer FIR filter taps compared to the AEC for a closed ambient environment. As another example, when the user chooses a closed room environment profile such as living room, that profile will not have advanced noise reduction algorithms. Thus, the user has flexibility to select the algorithms needed for each speaking environment.

If the user forgets to choose an environment, especially during low battery times, the user may be prompted by the user interface to choose one. The prompt from the user interface can occur in the form of a pop-up menu along with an incoming call notification as shown in FIG. 1. It may also occur independently of a call. This may be important to maintain some audio quality especially in situations where the battery reaches critically low levels. Rather than shutting down all audio processing to save battery life, the speech processing modules most important for a particular environment, fine tuned for that particular ambiance may be maintained. For example, if the user chooses “Traffic Around” as the environment from the pop-up menu, then the Traffic Noise Reduction (TNR) module may be invoked whereas it may otherwise be deactivated.

In another embodiment environment based profiles may be selected using NFC (Near Field Communication) tags. Other types of wireless systems, such as Bluetooth, WiFi, RFID (Radio Frequency Identification), and cellular telephone location information may also be used in a similar way. The NFC tags can be pre-configured for specific environments. Once the device gets paired with a particular NFC tag, the power-efficient profile with specific algorithms for that particular environment may be activated. This may also be used to save battery power. Just as NFC pairing may be used to activate a particular profile, Bluetooth pairing or a connection to a particular base station or access point or any other type of pairing may be used in a similar way to activate a particular environment-based profile.

In one example, there may be an NFC tag in the user's vehicle. When the user enters the vehicle, the mobile device pairs with the tag and then selects a profile that is particularly tuned for in-vehicle use. These may include echo cancellation, traffic noise reduction, and ambient noise adaptation. In another example, a user may have an NFC tag on a desktop charger in an office. When the user connects the mobile device to the charger then it pairs with that NFC tag and selects the modules that are best adapted for use in the office, these may include single channel noise reduction and minimal echo cancellation. Another NFC tag may be in a shopping center. The user can pair with the shopping center tag and then the mobile device can select modules particularly suitable for a shopping center environment.

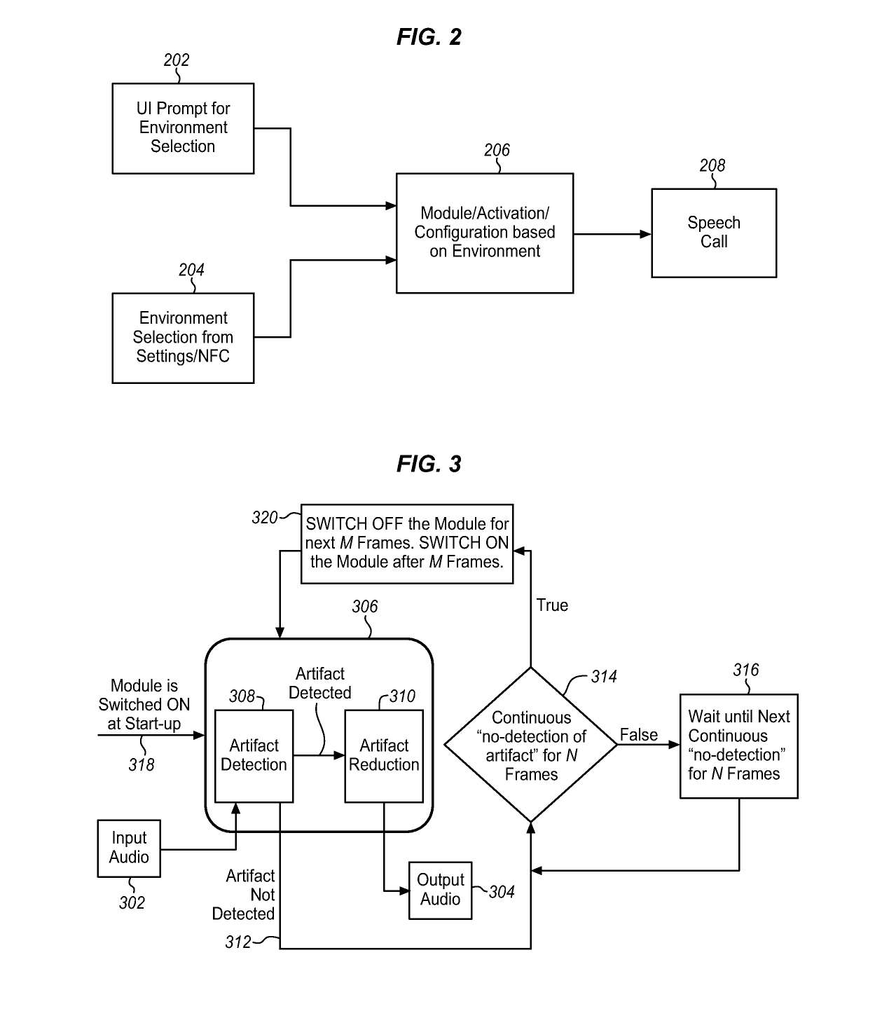

FIG. 2 presents a process flow of the operations described above. A first input 202 comes from a UI prompt to select an environment. The environment selected by the user in response to the prompt is applied to a configuration block 206. This block activates and configures the audio processing modules of the mobile device based on the input environment. A second input 204 is environment selections from a settings menu of the mobile device or from NFC tags. The mobile device may provide a settings menu to a user that can be accessed by the user at any time to select a current speaking or recording environment. These environments may then be related to standard audio processing profiles. The settings menu may also allow each response to each NFC tag to be configured. These selections are also provided to the configuration block. There may be additional sources of environment selection data depending on the particular implementation.

The configuration block 206, in response to these inputs, configures the mobile device for the particular environment. This configuration is then applied to a speech call 208. The configuration may also be applied to other events such as audio and video recording. The configuration block may operate by first selecting a profile based on the received environment selection data and then apply a configuration that is associated with the selected profile.

Instead of relying on a user to accurately select an environment, the mobile device may also be used to automatically select an environment based on feedback from its own audio processing modules or on information from its own internal sensors. In this way the environment may be detected automatically without user action. In the downlink direction, when producing remotely received audio through a speaker, an auto-selection of the appropriate environment may be used even when the receiving device does not have any information about the environment at the microphone of the transmitting device. Based on the auto-selection of an environment, the enhancement modules in both uplink and downlink directions may be automatically turned on and off throughout a speech call or recording session as the environment varies independently at the receiver and the transmitter over time.

Many audio enhancement modules have an artifact detection phase that may be used to determine whether to apply any audio enhancement. Other modules may be augmented to add a detection phase. Using the detection phase, it can be determined how many artifacts, if any, are detected. If the module is detecting only a few artifacts, then it is making only a very small enhancement to the audio. As a result it can be deactivated or de-powered.

FIG. 3 is a process flow diagram for using a module's artifact detection phase to determine whether the module should be activated. The module 306 has an artifact detection phase 308 and an artifact reduction phase 310. The nature of the artifacts and how they are reduced will depend on the particular module. The input audio 302 is received at the detection phase and the enhanced output audio is produced as an output 304. The audio input and output are part of an audio processing pipeline (not shown) that has additional modules and eventually passes the audio to a recorder, a transmitter, or a speaker. The input audio may be received from a microphone, a storage location, or a remote device through a receiver, such as a remote portable telephone.

The module is switched on at start-up 318. The start-up may be for the portable device as a whole or it may be a start-up for this particular audio enhancement module. The module may be started when a mode or an environment is detected for which this module is desired for use or by default. After start-up, the detection phase 308 of the module 306 continuously detects the artifacts in order to provide for the operation of the artifact reduction 310. The result 312 from the detection is also provided to a decision block 314. If a module continuously detects the environment as clean for a selected number of frames “N,” then at 320 the module is switched off for another selected number of frames “M.” After “M” frames, the module is switched on. This restarts the cycle in which the artifact detector operates for “N” frames to detect any artifacts. If in this cycle there are artifacts detected, then this indicates that there is a change in the environment. At the decision block if artifacts are detected within the “N” frames then the module is not switched off and the decision block 314 waits for another “N” continuous or sequential frames.

As a result of this process, the module will be auto-deactivated after “N” frames of “no-detection of artifacts.” By analyzing the input audio for artifacts, the module is, in effect monitoring the environment. If the module is echo cancellation, then it is monitoring 308, the input audio 302 for echoes that it is able to cancel. If the module is noise reduction, then it is monitoring the input audio for noise that it is able to reduce. These artifacts are all caused by the environment in which the audio is being produced whether in the uplink direction from a local microphone or the downlink direction at a remote microphone so that it is the environment that is being monitored by the artifact detection.

The results from the environment monitoring will be triggered at regular intervals to see if there is any change in the environment. If a change in the environment is detected, then audio enhancement will be performed until the next “N” continuous frames of “no detection of artifacts”. The values for “M” and “N” may be determined empirically from experimentation and validation. While “no detection of artifacts” may be a suitable standard in some cases, for other modules a threshold may be set. Even if there are some artifacts, the artifacts may be so few that the module is having little effect on the perceived quality of the audio. Instead of polling for no artifacts within a time period, a threshold may be used so that if the number of artifacts is below the threshold, then the module is switched off. The selection of the threshold may also be determined in any of a variety of different ways, including empirically.

The periodicity of the monitoring, that is the values for “M” and “N” may be modified as a function of the battery levels. For example, if the battery level is at 20%, the switching decision may happen every 2 seconds. If the battery level is lower, for example at 5%, then the switching decision may happen less frequently, for example every 10 seconds. This reduces the power consumed by the monitoring and decision process. The artifact threshold used to determine whether to switch the module on or off may also be varied with the battery level. As a result, when the battery is low more artifacts may be allowed for the module to be switched off.

As an alternative, the audio enhancement modules may be activated using a sensor-based environment detection process. The sensors may be used to detect if the user is either in a windy environment, in closed surroundings, in traffic, moving, or stationary. Based on the sensor inputs, a power efficient profile with only the appropriate enhancement modules may be activated for that particular environment.

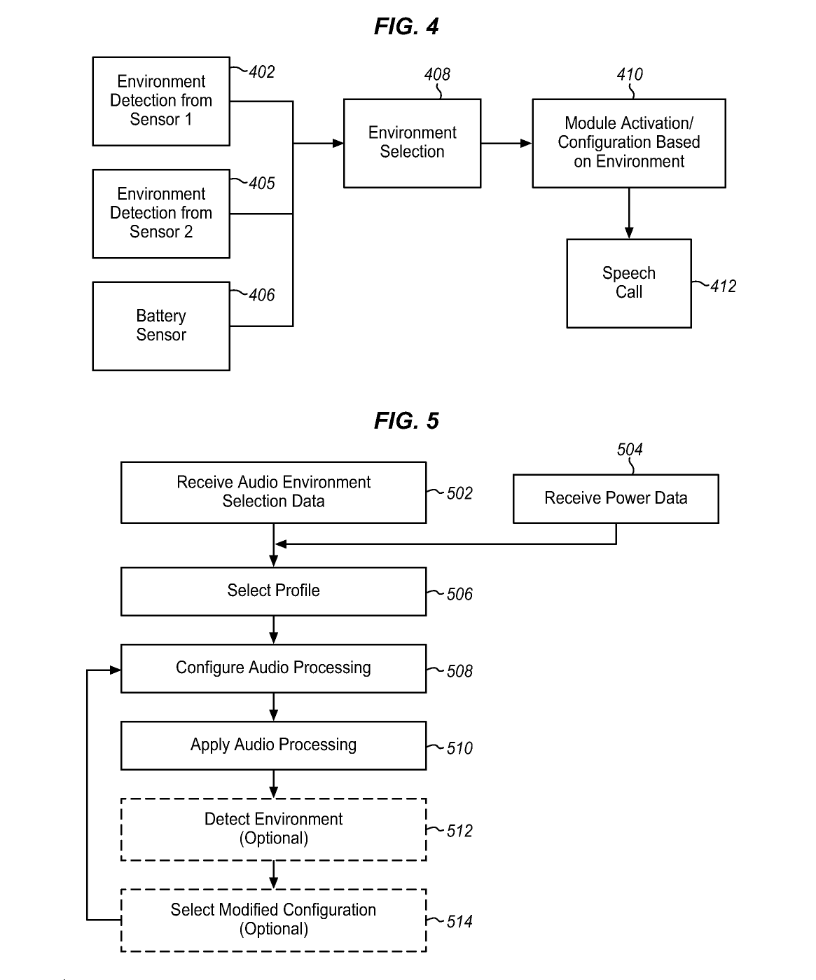

FIG. 4 is a process flow diagram to show the selection of an environment using sensors. The environment is detected using a first sensor 402 and a second sensor 405. This sensor information is applied to a selection block 408 to determine which environment to use. The selected environment is then applied to activate and configure the appropriate modules 410 based on the determined environment. In some embodiments, the configuration 410 includes using the environment to select a profile. The profile selection may include information such as a use mode and a user selection. All of these factors may be applied to a decision tree or look up table to determine an appropriate profile. The activated and configured modules are then applied to a speech call 412 or audio recording or any other suitable operation of the mobile device.

A variety of different sensors may be used. These may include microphones, pressure sensors, velocity sensors, accelerometers, thermometers, photodetectors, etc. A microphone or a pressure sensor independent of or coupled with a microphone may be used to determine if there is wind or echoes. A wind noise reduction module or echo cancellation module may then be activated. A microphone may also be used to determine if there are sounds that suggest an automobile (low rumble), an indoor moving environment such as a car or train interior, a crowded ambiance, a shopping center (diffuse echoed voices), or any of a variety of other environments. A thermometer may be used to determine if the mobile device is indoors (mild temperature) or outdoors (cold or hot temperature). A light sensor may also be used to determine if the device is indoors or outdoors. As an example, an ambient light level can be measured and then compared to a threshold light level. If the light level is higher than the light threshold then the current environment is determined to be outdoors. The other sensors for wind, temperature, and other parameters may be handled in a similar way.

Any of a variety of other sensor may be used alone or in combination to determine different audio environments. Velocity sensors may be used along with pressure sensors to determine, for example, an indoor moving environment such as inside a car or an outdoor moving environment such as riding on a motorcycle. If it is indoor and moving, a single channel noise reduction technique may be activated. In the case of outdoor and moving, advanced noise reduction techniques like WNR, MCNR, and TNR may also be activated.

In addition to the ambient environmental sensors, a battery sensor may also be used. The battery sensor 406 is applied to the environment selection 408 to determine if a lower clock rate, or reduced audio enhancement suite should be selected.

FIG. 5 is a process flow diagram for applying principles and techniques described above. At 502 audio environment selection data is received. As described herein this may be from user selection, NFC or other radio identification, module operation, artifact detection, or ambient sensors. Power data may also be received at 504. This may include the condition of the battery and also whether the mobile device is coupled to an external power supply. The environment and power data is used at 506 to select a profile. The profile may include a complete audio enhancement configuration or selecting the profile may also include selecting or a named environment or a combination of audio enhancement module configurations, depending on the particular system configuration and operation.

After an environment-based profile is determined or selected, the selection is applied to configure the audio processing at 508. For each audio enhancement module, the profile selection may be used to activate or deactivate the module and to set the appropriate module configuration ranging from maximum to minimum using commands. The commands may come from a processor, whether the central processor, a DSP, or an audio processor. The commands may change an operation rate, such as a processor, DSP, or operating core clock rate and the complexity of the operation, such as the number of filter taps. After the audio processing is configured, then it is applied to incoming audio at 510.

In many cases this initial configuration ends and the mobile device operates as configured until the end of the call or the recording session. However, in some embodiments the audio enhancement modules continue to operate to determine whether the mobile device configuration should be modified as described in the context of FIG. 3. These continued configuration updates may be used to provide a balance between good speech or audio enhancement along with good power efficiency. At 512 the environment is optionally detected by monitoring the operation of the modules. If the operations of the modules suggest that there should be any changes to the environment, then a modified configuration is optionally selected at 514. The selected modifications are then applied to the audio processing at 508. The mobile device continues to process the audio with the new configuration at 510 and the configuration may be fine-tuned continuously during the call or the recording session.

As mentioned above, in addition to the environment, the power state of the mobile device may be determined using a battery sensor. The module configuration and activations may then be adapted to suit the power state. In some embodiments, the clock for the modules, for example the clock rate to a DSP may be scaled down depending on the needed processing load of the modules for the required environment. In other embodiments, the number of filter taps may be reduced through the described environment-based module activation. Typically, audio DSPs are able to support different clock settings. As an example, an audio DSP may have a LOW, MEDIUM and HIGH clock setting corresponding to 108, 174 and 274 MHZ. Based on the environment-based module activation described herein, it may be determined that an environment is a clean environment for audio artifacts. As a result, the clock setting for an audio DSP may be reduced to LOW or MEDIUM. By lowering the clock frequency, the power consumption is reduced and battery power is conserved.

For audio with higher sampling rates such as Wideband (16 KHz), SuperWideBand (24/32 KHz), and Full-Band (48 KHz) speech, environment-based module activation and clock down-scaling will have an even greater impact on power consumption. For higher sampling rates, even while running at a HIGH clock to process all the samples power may be saved by switching off some of the modules. Good audio quality can be maintained by turning off the modules which are not needed and configuring the needed modules at full potential.

The Table is an example of how different environments might be applied to a variety of different audio enhancement modules. In this case each module has four modes indicated as OFF, 1, 2, and 3 which correspond to OFF, minimum configuration, medium configuration, and maximum configuration respectively. The mode for each module is selected based on the environment and may also be linked to the usage mode such as headset mode, speaker mode, Bluetooth mode, etc. The modules on the left-most column and the environments listed across the top row are provided as examples. There may be more or fewer modules with more or fewer modes. More or fewer environment may be used and any of these parameters may be changed to suit particular applications and uses of the mobile device.

As shown, for each environment there are different possible audio configurations. For the “Quiet Living Room” for example, the acoustic echo canceller may be set to level 2 or 3 and with a low battery it may be set to 1 or OFF. The selection of one of these four states in combination with the other modules is referred to herein as the selection of a profile. The profile selection 506 may consider one or more of the factors described here including user selection, the sensed environment, radio communication through NFC, WiFi etc., artifact detection by a module and the use mode. The profile may then be modified during a call or session by changes in the user selection, the sensed environment, radio communication, artifact detection, and battery condition.

The right-most column is indicated as a low power scenario in combination with the speaking environment. When a low battery condition is received from the power data 504, then the needed modules for the selected environment are activated with a bare minimum configuration. This allows an acceptable level of audio processing to be maintained while the drain on the battery is reduced. As an alternative or when the battery reaches a very low state, then the low power condition may be allowed to override all or most of the environments and all or most of the modules are set to the minimum power configuration or to OFF by adjusting clock speeds, reducing filter taps, reducing parameters, etc. This allows an even lower level of audio processing to be maintained while the drain on the battery is further reduced. The low battery condition may alternatively be used in combination with the environment so that only some of the modules are used and these are used in a very low power state. As an example, if the environment is “Silent Outdoor” then only the AEC module will be used and it will be set to level 1 or minimum.

The user may be provided with settings to configure how low battery conditions are handled. As an example, the user may select low battery along with an environment from the manual selections or settings (as described above). The first preference may then be given to the environment and then because the battery is draining, the very minimum configuration of the appropriate modules in the particular column will be run to extend the battery life. Alternatively, the user may select to ignore the battery condition entirely. Settings may also be established so that the battery condition is ignored until it reaches 20%, 10%, 5% or some other value.

TABLE

| | | | | | | Low Battery |
|---|---|---|---|---|---|---|
| | Quiet, | | | | | along with |
| | Living | Traffic | Silent | Windy | Buzzing | environment |
| Module | Room | Around | Outdoor | Outdoor | Crowd | selection |
| AEC | 2-3 | 1-2 | 1-2 | 1-2 | 1-2 | 1 or OFF |
| SCNR | OFF | 3 | OFF | OFF | 3 | 1 or OFF |
| MCNR | OFF | OFF | OFF | OFF | 3 | 1 or OFF |
| TNR | OFF | 3 | OFF | OFF | OFF | 1 or OFF |
| WNR | OFF | OFF | OFF | 3 | OFF | 1 or OFF |

The different audio enhancement modules of Table 4 are abbreviated as follows:
AEC—Acoustic Echo Canceller
SCNR—Single Channel/Microphone Noise Reduction
MCNR—Multi-Channel/Microphone Channel Noise Reduction
TNR—Traffic Noise Reduction
WNR—Wind Noise Reduction

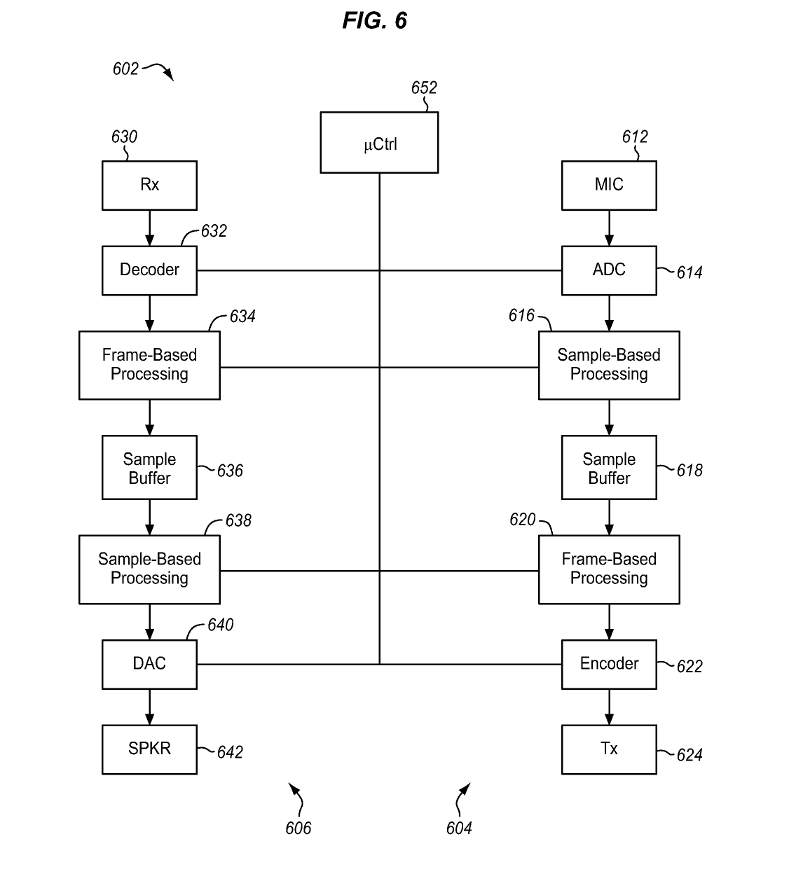

FIG. 6 is a block diagram of an audio pipeline 602. There is an uplink (UL) part of the pipeline 604 and a downlink (DL) part of the pipeline 606. Such an audio pipeline is typical for a mobile device, such as a smart phone, but may be present in any of a variety of different portable and fixed devices that send and receive speech or other audio. A similar pipeline may also be present in audio recorders and video cameras.

In the uplink part of the pipeline, speech data is received at one or more microphones 612, is digitized at the ADC (Analog to Digital Converter) 614, and is then fed into the uplink processing path. The received audio may come from human voices, a loudspeaker of the mobile device, or a variety of other sources. The uplink processing path has sample-based processing in a block 616, followed by frame-based processing 620. The processed samples are fed to a buffer to be accumulated until there are enough samples for a frame. The frames are sent to a speech encoder 622 and are then sent to a communications DSP 624 (also referred to as a modem DSP) which processes the frames for transmission over radio channels. The nature of the transmitter and how it is controlled depends on the particular interface and protocol for the transmission format. The diagram of FIG. 6 is not complete and there may be many other components in the pipeline and to make up the AFE (Audio Front End) of a device.

The downlink speech data is processed in the DL path 606 and is finally fed into the loudspeaker 642. The speech data is received from a receiver 630 such as a cellular radio receiver, WiFi receiver or a memory and then decoded 632. The frame processing block 634 divides the decoded speech into samples which are buffered 636 for processing in a sample processing block 638. The samples are fed to a DAC 640 to be output by the speaker 642.

The sample level processing blocks 616, 618, 638, 636 run based on a sample rate while the frame level processing blocks 620, 634 run on a frame rate. The various audio enhancement modules discussed herein may be implemented at either the sample level or frame level depending on the nature of the audio processing.

A microcontroller 652 generates and sets all of the configuration parameters, turns different modules on or off and sends interrupts to drive the AFE. The microcontroller may be a central processor for the entire system, a part of a SoC (System on a Chip), or a dedicated audio controller, depending on the implementation. The microcontroller sends interrupts at the sample rate to the ADC, DAC (Digital to Analog Converter) and sample-based processing modules. The microcontroller sends interrupts at the frame rate to the frame-based processing modules. The microcontroller may also generate interrupts to drive all of the other processes for the device, depending on the particular implementation.

The structure of the components of FIG. 6 may take many different forms. The microphones 612 are a transducer to convert analog acoustic waves that propagate through the ambient environment and convert these into analog electrical signals. The acoustic waves may correspond to speech, music, noise, machinery or other types of audio. The microphones may include the ADC 614 as a single component or the ADC may be a separate component. The ADC 614 samples the analog electrical waveforms to generate a sequence of samples at a set sampling rate. The sample-based processing 616, 638 may be performed in a DSP (Digital Signal Processor) that may or may not include the ADC and DAC. This audio DSP may also include the frame-based processing 620, 634 or the frame-based processing may be performed by a different component. The interrupts may be generated by an AFE that is included in an audio DSP or the AFE may be a separate component including a general purpose processor that manages different types of processes in addition to audio pipelines.

The AFE (Audio Front End) is formed from hardware logic and may also have a software component including a counterpart driver. After the ADC 614 starts sampling the analog signal, the digital samples are stored in a buffer 616. After the sample-based processing, the processed samples are stored in a frame buffer 618.

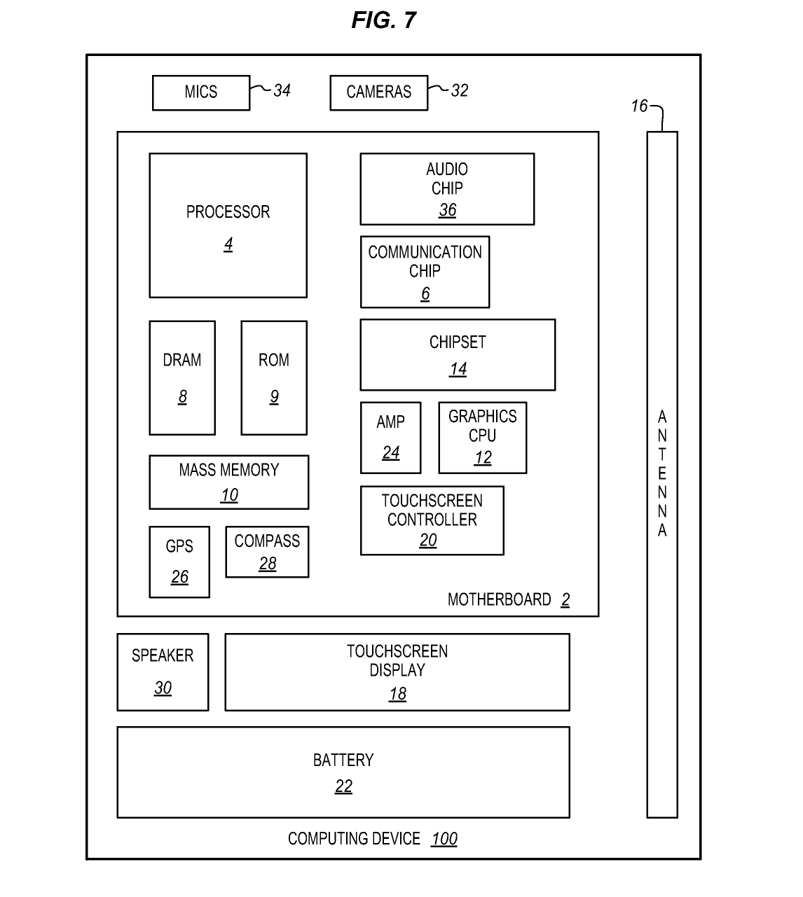

FIG. 7 illustrates a computing device 100 in accordance with one implementation of the invention. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The microphones 34 and the speaker 30 are coupled to one or more audio chips 36 to perform digital conversion, encoding and decoding, and audio enhancement processing as described herein. The processor 4 is coupled to the audio chip, through an audio front end, for example, to drive the process, set parameters, and control operations of the audio chip. Frame-based processing may be performed in the audio chip or in the communication package 6. Power management functions may be performed by the processor, coupled to the battery 22 or a separate power management chip may be used.

In various implementations, the computing device 100 may be a laptop, a netbook, a notebook, an ultrabook, a smartphone, a wearable device, a tablet, a personal digital assistant (PDA), an ultra mobile PC, a mobile phone, a desktop computer, a server, a printer, a scanner, a monitor, a set-top box, an entertainment control unit, a digital camera, a portable music player, or a digital video recorder. The computing device may be fixed, portable, or wearable. In further implementations, the computing device 100 may be any other electronic device that processes data.

Embodiments may be implemented as a part of one or more memory chips, controllers, CPUs (Central Processing Units), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method that includes determining a current environment of a mobile device, selecting a profile based on the current environment, configuring an audio processing pipeline based on the selected profile, and processing audio received of the mobile device through the configured audio processing pipeline.

In further embodiments determining a current environment includes presenting a list of environments to a user, receiving a selection of one of the listed environments from the user, applying the user selection as the current environment.

In further embodiments determining a current environment comprises measuring characteristics of the environment using sensors of the mobile device. In further embodiments measuring comprises measuring an ambient temperature using a thermometer and wherein the current environment is determined to be outdoors if the temperature is higher than a first temperature threshold or lower than a second temperature threshold. In further embodiments measuring comprises measuring a wind velocity using a microphone and or a pressure sensor and wherein the current environment is determined to be outdoors if the wind velocity is higher than a wind threshold. In further embodiments measuring comprises measuring an ambient light level and wherein the current environment is determined to be outdoors if the light level is higher than a light threshold. In further embodiments velocity sensors may be used along with pressure sensors to determine an indoor moving environment or an outdoor moving environment.

In further embodiments configuring an audio processing pipeline comprises disabling a speech processing module. In further embodiments disabling comprises disconnecting power from the module. In further embodiments configuring an audio processing pipeline comprises setting a clock rate of an audio processor. In further embodiments configuring an audio processing pipeline comprises modifying modules' parameters through a command or by other means of audio scheduler.

Further embodiments include processing audio received from a speech decoder of the mobile device and played back through a speaker of the mobile device. Further embodiments include detecting artifacts in the received audio at an audio enhancement module of the audio processing pipeline and adjusting the operation of the audio enhancement module based on the detecting.

In further embodiments adjusting the operation comprises determining whether artifacts are detected within a predetermined number of frames of digital received audio and if no artifacts are detected then switching off the module for a predetermined number of frames. In further embodiments selecting a profile comprises receiving an environment detection from a sensor and receiving an environment selection from a user and selecting the profile based thereon. In further embodiments selecting a profile comprises receiving battery sensor information and selecting the profile based on the current environment and the battery sensor information.

Some embodiments pertain to a machine-readable medium having instructions that when operated on by the machine cause the machine to perform operations that include determining a current environment of a mobile device, selecting a profile based on the current environment, configuring an audio processing pipeline based on the selected profile, and processing audio received of the mobile device through the configured audio processing pipeline.

In further embodiments determining a current environment comprises receiving characteristics of the environment from sensors of the mobile device. In further embodiments configuring an audio processing pipeline comprises setting configuration modes for a plurality of audio enhancement modules of the audio processing pipeline. In further embodiments the configuration modes comprise a plurality of active modes and an OFF mode.

Some embodiments pertain to an apparatus that includes means for determining a current environment of a mobile device, means for selecting a profile based on the current environment, means for configuring an audio processing pipeline based on the selected profile, and the audio processing pipeline for processing audio received at a microphone of the mobile device.

Further embodiments include a user interface for presenting a list of environments to a user and for receiving a selection of one of the listed environments from the user, wherein the means for selecting applies the user selection as the current environment. Further embodiments include sensors of the mobile device for measuring characteristics of the environment for use by the means for determining a current environment. In further embodiments the audio processing pipeline comprises a plurality of audio enhancement modules and wherein the means for configuring enables and disables the audio enhancement modules based on the selected profile.

Some embodiments pertain to an apparatus that includes a microphone to receive audio, an audio processing pipeline having a plurality of audio enhancement modules to process the audio received at the microphone, a sensor of a mobile device to determine a current environment of a mobile device, and a controller to receive the determined environment, to select a profile based on the received current environment, and to configure the audio processing pipeline based on the selected profile.

Some embodiments pertain to an apparatus that includes a receiver to receive audio produced at a remote microphone, an audio processing pipeline having a plurality of audio enhancement modules to process the downlink audio, artifact detection of the environment at the remote microphone, and a controller to receive the determined environment, to select a profile based on the detected environment in the downlink, and to configure the audio processing pipeline based on the selected profile.

Further embodiments include a user interface of the mobile device coupled to the controller, the user interface to present a list of environments to a user, receive a selection of one of the listed environments from the user, and provide the user selection to the controller as the current environment.

In further embodiments the sensor comprises a thermometer to measure an ambient temperature and wherein the controller determines the current environment to be outdoors if the temperature is higher than a first temperature threshold or lower than a second temperature threshold. In further embodiments the sensor comprises a pressure sensor to measure a wind velocity and wherein the controller determines the current environment to be outdoors if the wind velocity is higher than a wind threshold. In further embodiments the sensor comprises a light meter to measure an ambient light level and wherein the controller determines the current environment is determined to be outdoors if the light level is higher than a light threshold.

In further embodiments the controller configures the audio processing pipeline by enabling and disabling audio enhancement modules of the speech processing pipeline. In further embodiments the controller configures the audio processing pipeline by disconnecting power from at least one audio enhancement module. In further embodiments the controller configures the audio processing pipeline by setting a clock rate of an audio processor. In further embodiments an audio enhancement module detects artifacts in the received audio and adjusts the operation of the audio enhancement module based on the detecting. In further embodiments adjusting the operation comprises determining whether artifacts are detected within a predetermined number of frames of digital received audio and if no artifacts are detected then switching off the module for a predetermined number of frames.

What is claimed is:

1. A method comprising:
determining a current environment of a mobile device;
selecting a profile based on the current environment;
configuring an audio processing pipeline based on the selected profile; and
processing audio received at the mobile device through the configured audio processing pipeline.

2. The method of claim 1, wherein determining a current environment comprises measuring characteristics of the environment using sensors of the mobile device and wherein the current environment is determined by comparing the measured characteristic to a threshold.

3. The method of claim 1, further comprising processing audio received from a speech decoder of the mobile device and played back through a speaker of the mobile device.

4. The method of claim 1, further comprising detecting artifacts in the received audio at an audio enhancement module of the audio processing pipeline and adjusting the operation of the audio enhancement module based on the detecting.

5. The method of claim 4, wherein adjusting the operation comprises determining whether artifacts are detected within a predetermined number of frames of digital received audio and if no artifacts are detected then switching off the module for a predetermined number of frames.

6. The method of claim 1, wherein selecting a profile comprises receiving battery sensor information and selecting the profile based on the current environment and the battery sensor information.

7. A machine-readable medium having instructions that when operated on by the machine cause the machine to perform operations comprising:
determining a current environment of a mobile device;
selecting a profile based on the current environment;
configuring an audio processing pipeline based on the selected profile; and
processing audio received at the mobile device through the configured audio processing pipeline.

8. The medium of claim 7, wherein configuring an audio processing pipeline comprises setting configuration modes for a plurality of audio enhancement modules of the audio processing pipeline.

9. An apparatus comprising:
means for determining a current environment of a mobile device;
means for selecting a profile based on the current environment;
means for configuring an audio processing pipeline based on the selected profile; and
the audio processing pipeline for processing audio received at a microphone of the mobile device.

10. The apparatus of claim 9, further comprising a user interface for presenting a list of environments to a user and for receiving a selection of one of the listed environments from the user, wherein the means for selecting applies the user selection as the current environment.

11. An apparatus comprising:
a microphone to receive audio;
an audio processing pipeline having a plurality of audio enhancement modules to process the audio received at the microphone;
a sensor of a mobile device to determine a current environment of a mobile device; and
a controller to receive the determined environment, to select a profile based on the received current environment, and to configure the audio processing pipeline based on the selected profile.

12. The apparatus of claim 11, further comprising a user interface of the mobile device coupled to the controller, the user interface to:
present a list of environments to a user;
receive a selection of one of the listed environments from the user;
provide the user selection to the controller as the current environment.

13. The apparatus of claim 11, wherein the sensor comprises a thermometer to measure an ambient temperature and wherein the controller determines the current environment to be outdoors if the temperature is higher than a first temperature threshold or lower than a second temperature threshold.

14. The apparatus of claim 11, wherein the sensor comprises a pressure sensor to measure a wind velocity and wherein the controller determines the current environment to be outdoors if the wind velocity is higher than a wind threshold.

15. The apparatus of claim 11, wherein the sensor comprises a light meter to measure an ambient light level and wherein the controller determines the current environment is determined to be outdoors if the light level is higher than a light threshold.

16. The apparatus of claim 11, wherein the controller configures the audio processing pipeline by enabling and disabling audio enhancement modules of the speech processing pipeline.

17. The apparatus of claim 11, wherein the controller configures the audio processing pipeline by disconnecting power from at least one audio enhancement module.

18. The apparatus of claim 11, wherein the controller configures the audio processing pipeline by setting a clock rate of an audio processor.

19. The apparatus of claim 11, wherein an audio enhancement module detects artifacts in the received audio and adjusts the operation of the audio enhancement module based on the detecting.

20. The apparatus of claim 19, wherein adjusting the operation comprises determining whether artifacts are detected within a predetermined number of frames of digital received audio and if no artifacts are detected then switching off the module for a predetermined number of frames.
